(19) United States
(12) Patent Application Publication
(10) Pub. No.: US 2015/0175149 A1
(43) Pub. Date: Jun. 25, 2015

(54) SYSTEM AND METHOD FOR ENGINE IDLE STOP CONTROL

(71) Applicant: FORD GLOBAL TECHNOLOGIES, LLC, DEARBORN, MI (US)

(72) Inventors: Yanan Zhao, Ann Arbor, MI (US); Mathew Alan Boesch, Plymouth, MI (US); Sangeetha Sangameswaran, Canton, MI (US)

(73) Assignee: FORD GLOBAL TECHNOLOGIES, LLC, DEARBORN, MI (US)

(21) Appl. No.: 14/133,726

(22) Filed: Dec. 19, 2013

(51) Int. Cl. B60W 20/00; F02D 29/02; F02D 28/00

(52) U.S. Cl. CPC B60W 20/00; F02D 28/00; F02D 29/02; Y10S 903/903

(57) ABSTRACT

A system and method for controlling engine idle stop in a hybrid vehicle balance the extra electrical load imposed on the vehicle during engine stop with the electrical energy saved to achieve net fuel savings. Predictive information is used to determine potential vehicle stops and corresponding stop durations during a time window. To achieve net fuel savings, the engine stop duration time must be long enough for the electrical energy savings to cover electrical load added to the system. If the predicted stop duration time is long enough to yield net fuel savings, engine stop may be initiated. If not, engine stop may be inhibited.

### TECHNICAL FIELD

The present disclosure relates to vehicles with an engine auto-stop feature and controlling engine idle stop and restart activities.

### BACKGROUND

A hybrid vehicle may be equipped with an engine auto-stop system. An engine auto-stop system shuts down the engine during certain periods of vehicle operation to conserve fuel. For example, engine auto-stop may be engaged when the vehicle is stopped at a traffic light or in a traffic jam rather than permitting the engine to idle. The engine may be restarted when the driver releases the brake or actuates the accelerator pedal. The engine may also be started, for example, due to loads on the electrical system. Stopping the engine when it is not needed improves fuel economy and reduces emissions.

Engine auto-stop systems may also pose various challenges. An engine stop and restart event causes extra electrical load to be imposed on the system. For example, additional electrical energy is required to restart the engine, to run an electric pump to keep line pressure and reduce engine restart time, and to run an auxiliary heater core pump to maintain cabin comfort. However, during engine stop, there are electrical energy savings as well because some components that are related to engine operations are turned off. These may include the engine cooling fan, air conditioning clutch, fuel pump, fuel injector, and a spark plug coil, for example. Accordingly, there is a need to develop engine auto-stop control strategies that balance the extra electrical load imposed on the vehicle with electrical energy saved during engine stop and restart to achieve net fuel savings.

### SUMMARY

A system and method for controlling engine idle stop in a hybrid vehicle that balances the extra electrical load imposed on the vehicle during engine stop with the electrical energy saved to achieve net fuel savings is disclosed. Specifically, embodiments disclosed herein use predictive information to generate a predicted vehicle stop profile that depicts potential stop events, along with corresponding vehicle stop duration times, over a specified period of time. A controller may be configured to determine whether a predicted vehicle stop duration time for a vehicle stop event is sufficient to yield net fuel savings. If the predicted stop duration time is long enough to yield net fuel savings, the engine is shut down. If not, engine stop is inhibited.

In one embodiment, a hybrid vehicle includes an engine and a starter motor configured to start the engine. The vehicle also includes a controller configured to inhibit engine stop during a vehicle stop event in response to a predicted vehicle stop duration time being below a minimum engine stop time. The minimum engine stop time is based on electrical load of components started in response to the engine stop and electrical load of the starter motor to restart the engine. The controller is also configured to shut the engine off during the vehicle stop event in response to the predicted vehicle stop duration time exceeding the minimum engine stop time. The minimum engine stop time is further based on a difference between a total added electrical load associated with components that are turned on and a total saved electrical load associated with the components that are turned off during engine stop and restart.

In another embodiment, a hybrid vehicle includes a controller configured to shut the engine off during a vehicle stop event in response to a predicted vehicle stop time exceeding a corresponding engine stop threshold based on vehicle energy consumption with the engine on relative to vehicle energy consumption with the engine off during the vehicle stop event. In addition, the vehicle energy consumption associated with components turned on and off during the vehicle stop event is estimated from current draw of the component, vehicle system voltage, and duration of on and off time of the component. The engine stop threshold is further based on at least one of a fuel consumption rate at engine idle, a fuel energy density, an engine efficiency, and an alternator efficiency.

In yet another embodiment, a method for controlling a hybrid vehicle includes controlling engine stop during a vehicle stop event in response to a comparison of a predicted vehicle stop duration relative to a minimum engine stop time. The minimum engine stop time is based on vehicle energy consumption with the engine running relative to vehicle energy consumption with the engine off during the engine stop and restart.

Embodiments according to the present disclosure provide various advantages. For example, various embodiments achieve net fuel savings by balancing electrical energy added to the system with electrical energy savings during engine stop and restart. The above advantages and other advantages and features will be readily apparent from the following detailed description of the preferred embodiments when taken in connection with the accompanying drawings.

### BRIEF DESCRIPTION OF THE DRAWINGS

FIG. 1 is a schematic representation of a powertrain system configuration capable of implementing embodiments of the present disclosure;

FIG. 2 illustrates a predicted vehicle stop profile depicting potential vehicle stop events within a time window in accordance with embodiments of the present disclosure;

FIG. 3 is a block diagram illustrating a system and method of engine idle stop control according to an exemplary embodiment of the present disclosure.

### DETAILED DESCRIPTION

As required, detailed embodiments of the claimed subject matter are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments of the claimed subject matter.

A hybrid vehicle may be equipped with an engine auto-stop system. An engine auto-stop system shuts down the engine during certain periods of vehicle operation to conserve fuel. For example, the auto-stop system may shut the engine off during engine idle conditions where the engine is not required for propulsion or other purposes. The auto-stop system may then restart the engine when required for propulsion or other purposes. By disabling the engine when possible, overall fuel consumption is reduced. However, unlike true hybrid vehicles, vehicles with an auto-stop feature are not capable of pure electric propulsion and are not equipped with a traction battery, but rather with a conventional starting, lighting, and ignition (SLI) battery.

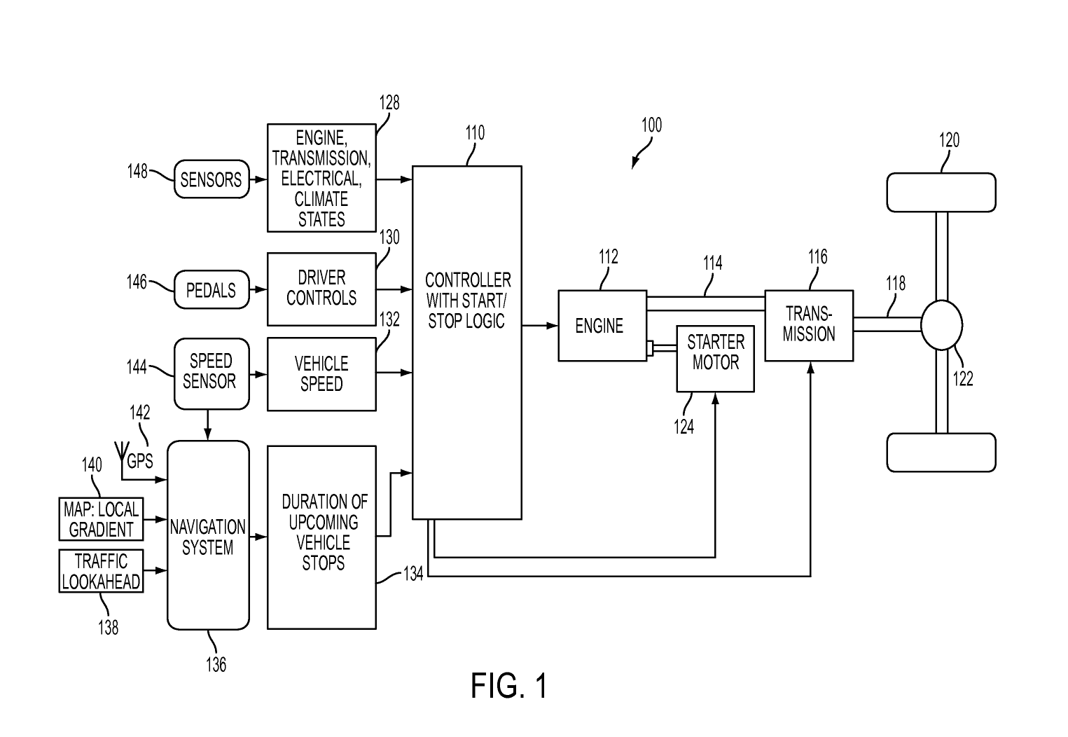

Referring to FIG. 1, a schematic representation of a vehicle powertrain configuration 100 having auto-stop functionality that is capable of implementing the control strategies disclosed herein is shown. A vehicle control system, shown generally as controller 110, may be provided to control various components and subsystems of the vehicle, and include appropriate start/stop logic and/or controls for controlling an engine auto-stop system. Controller 110 may generally include any number of microprocessors, ASICs, ICs, memory (e.g., FLASH, ROM, RAM, EPROM and/or EEPROM) and software code that cooperate with one another to perform a series of operations. The controller 110 may communicate with other controllers over a vehicle-wide network, such as a controller area network (CAN). The CAN may be a hardline vehicle connection (e.g., bus) and may be implemented using any number of communication protocols generally known.

Controller 110 may be configured to initiate an auto-stop or auto-start of the engine 112 during various operating conditions. As the vehicle comes to a stop, for example, controller 110 may issue a command to begin the process to stop the engine 112, thus preventing the alternator or integrated starter generator from providing electric current to the electrical loads. The battery may provide electric current to the electrical loads while the engine is stopped. As the brake pedal is disengaged (and/or the accelerator pedal is engaged) after an engine auto-stop, the controller may issue a command to begin the process to start the engine, thus enabling the alternator or integrated starter generator to provide electric current to the electrical loads.

In general, controller 110 receives input from various vehicle sensors 148 that indicate engine, transmission, electrical and climate states 128. The vehicle speed 132 is also communicated to controller 110 through speed sensor 144. The controller 110 further receives input from driver controls 130, such as the accelerator and brake pedals 146, and a navigation system 136 that provides information to predict and determine durations of upcoming vehicle stop events 134. The navigation system 136 may receive information from the vehicle speed sensor 144, GPS 142, local gradient maps and sensors 140, and/or traffic flow data 138. In one configuration, the navigation system 136 may be an in-vehicle GPS system. In another configuration, the navigation system 136 may comprise a location-enabled mobile device, such as a cellular phone or standalone GPS unit. Other configurations are, of course, also possible. The controller 110 may generally implement engine stop and start, with one or more of the additional features provided by embodiments of the disclosure as described in further detail below.

With continual reference to FIG. 1, an internal combustion engine 112, controlled by controller 110, distributes torque through torque input shaft 114 to transmission 116. The transmission 116 includes a torque output shaft 118 drivably connected to vehicle traction wheels 120 through a differential and axle mechanism 122. A starter motor 124 is provided that is capable of restarting the engine during start/stop events. Other aspects of the powertrain system 100 illustrated in FIG. 1 may be implemented in a known fashion as is appreciated by those skilled in the art. Further, embodiments of the present disclosure are not limited to the particular illustrated powertrain configuration.

As previously discussed, implementing engine auto-stop control strategies may pose various challenges. Engine stop and restart events cause extra electrical load to be imposed on the system. For example, additional electrical energy is required to restart the engine, to run an electric pump to keep line pressure and reduce engine restart time, and to run an auxiliary heater core pump to maintain cabin comfort. However, during engine stop, there are electrical energy savings as well because some components that are related to engine operations are turned off. These may include, the engine cooling fan, air conditioning clutch, and fuel pump, a fuel injector, and a spark plug coil, for example. The net fuel saving is offset by the above extra electrical load and electrical energy savings.

Engine idle stop in a hybrid vehicle can be controlled, based on vehicle energy consumption, to balance the extra electrical load imposed on the vehicle during engine stop with the electrical energy saved to achieve net fuel savings through the use of predictive information. Specifically, embodiments disclosed herein use predictive information to generate a predicted vehicle stop profile that depicts potential vehicle stop events, along with corresponding vehicle stop duration times, over a specified period of time. A controller may then be configured to determine whether the predicted vehicle stop duration time is sufficient to yield net fuel savings. If the predicted vehicle stop duration time is long enough to yield net fuel savings, the controller may command the engine to shut down. If not, the controller may inhibit engine stop.

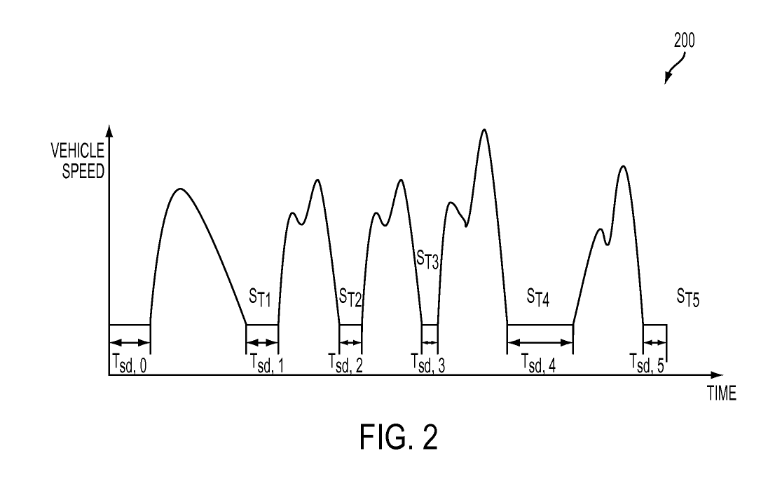

The predictability of vehicle stop duration times has improved due to the development and deployment of technologies such as Global Positioning Systems (GPS), Geographic Information Systems (GIS), Vehicle-to-Vehicle (V2V) Communications, Vehicle-to-Infrastructure (V2I) Communications, and traffic flow monitoring systems. Once an intended route is available, a predicted vehicle stop profile can be constructed based on map data, road attributes, real-time and historic traffic information, and/or past driving history of the driver. FIG. 2, for example, illustrates an example predicted vehicle stop profile 200 that shows a set of vehicle stop duration times (T_{sd,1}, T_{sd,2}, T_{sd,3}, T_{sd,4}, T_{sd,5}) corresponding to a set of predicted vehicle stop events (S_{T1}, S_{T2}, S_{T3}, S_{T4}, S_{T5}) within a time window.

During each vehicle stop event, the change in electrical load between the electrical energy added to the system from components turned on during engine stop/start and electrical energy saved from components turned off can be estimated as shown in Equation (1). In Equation 1, E_{added} is the total electric load associated with the components that need to be turned on during engine stop and restart, and E_{saved} is the total electric load associated with the components that are turned off during engine stop. The powertrain related loads considered are expressed in Equations (1a) and (1b).

ΔE_{load}=E_{added}−E_{saved} (1)

E_{added}=E_{start motor}+E_{trans aux pump}+E_{aux heater core pump} (1a)

E_{saved}=E_{cooling fan}+E_{ACclutch}+E_{fuel pump}+E_{Fuel Injector}+E_{Spark Plug Coils}+ELSE (1b)

The electrical load that is added or saved by each component can be estimated based on the integration of its current draw multiplied by the vehicle system voltage along the duration of the component on or off time. The above equations can also be extended to include non-powertrain related electrical loads such as blowers, heated seats, heated steering wheel, electronic power assisted steering (EPAS), rear defrost, and/or side mirror heat, for example. Depending on the driving conditions, the components included in the non-powertrain related load may be different.

To achieve net fuel savings, the engine stop duration time must be long enough to cover the change in electrical load ΔE_{load}. The minimum engine stop duration time in which the change in electrical load can just be compensated by the fuel saving can be calculated as shown in Equation (2). In Equation (2), \dot{m} is the fuel consumption rate at engine idle, p is the fuel energy density, η_{eng} is the engine efficiency, and ηₐₗₜ is the alternator efficiency.

$${T}_{m i n , stop} = \frac{Δ {E}_{load}}{\dot{m} {ρη}_{eng} {η}_{alt}} \qquad ( 2 )$$

Engine stop is permitted only when the predicted vehicle stop duration time (T_{sd}) of the vehicle stop event exceeds the estimated minimum engine stop time, as shown in Equation (3).

T_{sd}>T_{min,stop} (3)

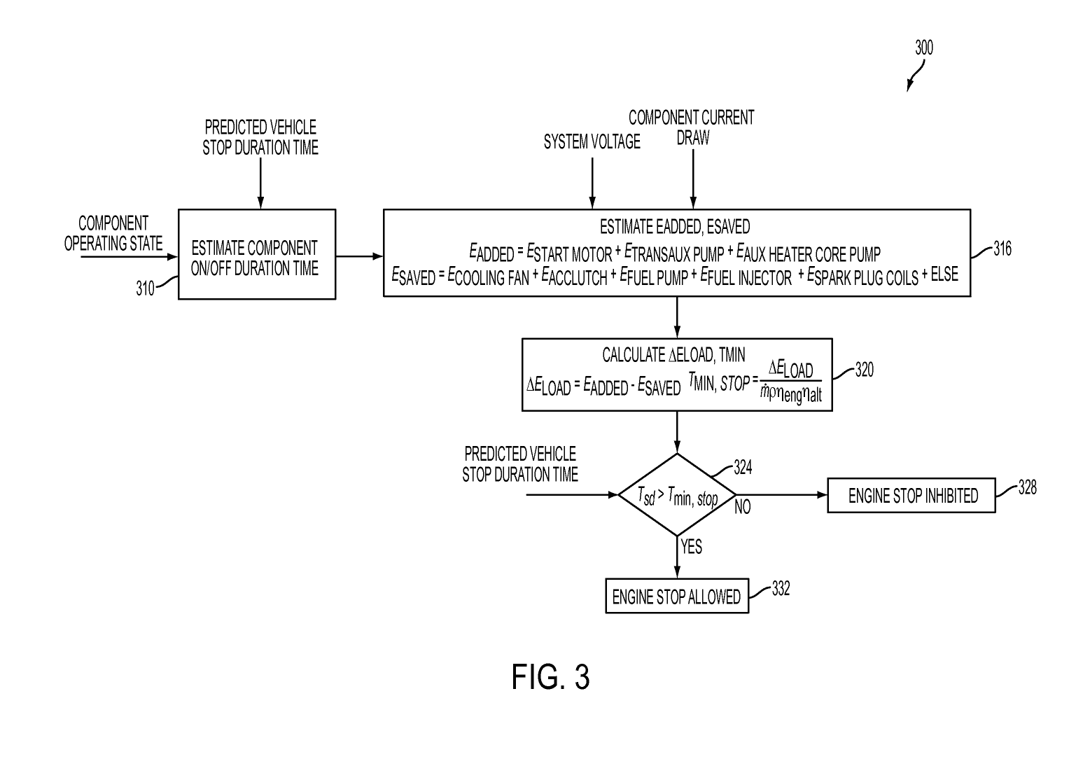

Referring to FIG. 3, operation of a system or method for controlling engine stop/start events of a vehicle according to an exemplary embodiment of this disclosure is shown. As those of ordinary skill in the art will understand, the functions represented by the flow chart blocks may be performed by software and/or hardware. Depending upon the particular processing strategy, such as event-driven, interrupt-driven, etc., the various functions may be performed in an order or sequence other than illustrated in the Figure. Similarly, one or more steps or functions may be repeatedly performed, although not explicitly illustrated. In one embodiment, the functions illustrated are primarily implemented by software, instructions, or code stored in a computer readable storage medium and executed by one or more microprocessor-based computers or controllers to control operation of the vehicle.

As shown in FIG. 3, the control strategy 300 begins at block 310 where a powertrain component's on and off duration time is estimated from the component operating state and the predicted vehicle stop duration time of the vehicle stop event. At block 316, the total electrical load added to the system during engine stop and restart is calculated from system voltage and the component's current draw. The total electrical load added is determined from the electrical load associated with components turned on during engine stop/start such as the starter motor, transmission auxiliary pump and an auxiliary heater core pump. The electrical load saved from components turned off during engine stop is also calculated at block 316. Electrical load saved is based on electrical load associated with components such as the cooling fan, air conditioning clutch, fuel pump, fuel injector and a spark plug coil, for example. The difference in the electrical load added to the system and the electrical load saved is calculated at block 320. A minimum engine stop time is calculated from the change in electrical load, a fuel consumption rate at engine idle, a fuel energy density, an engine efficiency, and an alternator efficiency, as shown at 320. At block 324, the predicted vehicle stop duration time is compared with the minimum engine stop time. If the predicted vehicle stop duration time exceeds the minimum engine stop time, then the controller initiates engine stop 332. If the predicted vehicle stop duration time is not greater than the minimum engine stop time, then the engine stop is inhibited 328.

As can be seen by the representative embodiments described, embodiments according to the present disclosure help mitigate the challenges posed by stop/start vehicles and achieve net fuel savings by balancing the extra electrical load imposed on the vehicle with electrical energy saved during engine stop and restart.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure. While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A hybrid vehicle, comprising:
an engine;
a starter motor configured to start the engine; and
a controller configured to inhibit engine stop during a vehicle stop event in response to a predicted vehicle stop duration time being below a minimum engine stop time, wherein the minimum engine stop time is based on electrical load of components started in response to the engine stop and electrical load of the starter motor to restart the engine.

2. The hybrid vehicle of claim 1, further comprising:
the controller configured to shut the engine off during the vehicle stop event in response to the predicted vehicle stop duration time exceeding the minimum engine stop time.

3. The hybrid vehicle of claim 1, wherein the minimum engine stop time is further based on a difference between a total added electrical load associated with components that are turned on and a total saved electrical load associated with the components that are turned off during engine stop and restart.

4. The hybrid vehicle of claim 3, wherein the electrical load of each component turned on and off during engine stop and restart is estimated from current draw of the component, vehicle system voltage, and duration of on and off time of the component.

5. The hybrid vehicle of claim 3, wherein the components that are turned on during engine stop and restart include at least one of the starter motor, a transmission auxiliary pump, and an auxiliary heater core pump.

6. The hybrid vehicle of claim 3, wherein the components turned off in response to engine stop include at least one of a cooling fan, an air conditioning clutch, a fuel pump, a fuel injector, and a spark plug coil.

7. The hybrid vehicle of claim 1, wherein the minimum engine stop time is further based on a fuel consumption rate at engine idle, a fuel energy density, an engine efficiency, and an alternator efficiency.

8. The hybrid vehicle of claim 1, wherein the predicted vehicle stop duration time is determined from a predicted vehicle stop profile generated using predictive information, wherein predictive information includes at least one of map data, road attributes, real-time traffic information, historic traffic information, and past driving history.

9. The hybrid vehicle of claim 1, wherein the vehicle stop event corresponds to an engine idle condition, wherein the engine idle condition occurs when a vehicle speed is below a minimum speed threshold and a brake pedal is depressed.

10. A hybrid vehicle, comprising:
an engine;
a starter motor configured to start the engine; and
a controller configured to initiate engine stop during a vehicle stop event in response to a predicted vehicle stop time exceeding a corresponding engine stop threshold based on vehicle energy consumption with the engine on relative to vehicle energy consumption with the engine off during the vehicle stop event.

11. The hybrid vehicle of claim 10, wherein the controller is further configured to inhibit engine stop during the vehicle stop event in response to the predicted vehicle stop time being below the engine stop threshold.

12. The hybrid vehicle of claim 10, wherein the vehicle energy consumption associated with components turned on and off during the vehicle stop event is estimated from current draw of the component, vehicle system voltage, and duration of on and off time of the component.

13. The hybrid vehicle of claim 10, wherein the engine stop threshold is further based on at least one of a fuel consumption rate at engine idle, a fuel energy density, an engine efficiency, and an alternator efficiency.

14. A method for controlling a hybrid vehicle having an engine and a starter motor, comprising:
controlling engine stop during a vehicle stop event in response to a comparison of a predicted vehicle stop duration relative to a minimum engine stop time, wherein the minimum engine stop time is based on vehicle energy consumption with the engine running relative to vehicle energy consumption with the engine off during the engine stop and restart.

15. The method of claim 14, further comprising:
shutting the engine off during the vehicle stop event in response to the predicted vehicle stop duration exceeding the minimum engine stop time.

16. The method of claim 14, further comprising:
inhibiting engine stop in response to the predicted vehicle stop duration being below the minimum engine stop time.

17. The method of claim 14, wherein vehicle energy consumption with the engine running is calculated from an electrical load associated with at least one of a cooling fan, an air conditioning clutch, a fuel pump, a fuel injector, and a spark plug coil.

18. The method of claim 14, wherein vehicle energy consumption with the engine off is calculated from an electrical load associated with at least one of the starter motor, a transmission auxiliary pump, and an auxiliary heater core pump.

19. The method of claim 14, wherein the minimum engine stop time is further based on a fuel consumption rate at engine idle, a fuel energy density, an engine efficiency, and an alternator efficiency.

20. The method of claim 14, wherein the predicted vehicle stop duration is determined from a predicted vehicle stop profile generated using predictive information, wherein predictive information includes at least one of map data, road attributes, real-time traffic information, historic traffic information, and past driving history.
